(19) United States
(12) Patent Application Publication
(10) Pub. No.: US 2008/0122920 A1
(43) Pub. Date: May 29, 2008

(54) WEB SERVER AND METHOD FOR MONITORING SYSTEM

(75) Inventor: Ching-Shan Chang, Taipei County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, omitted

(73) Assignee: APPRO TECHNOLOGY INC., Taipei County (TW)

(21) Appl. No.: 11/621,572

(22) Filed: Jan. 10, 2007

(30) Foreign Application Priority Data
Nov. 24, 2006 (TW) 95143493

(51) Int. Cl. H04N 7/14

(52) U.S. Cl. 348/14.01; 348/E07.077

(57) ABSTRACT

A web server for a monitoring system and a method thereof are provided. With a free website, users can watch monitoring images any where at any time by registering cameras on the website. The web sever provides such functions as camera management, monitoring image management, data storage, image edit, etc so that a user can easily set up a personal monitoring system on the website.

### CROSS-REFERENCE TO RELATED APPLICATION

This application claims the priority benefit of Taiwan application serial no. 95143493, filed on Nov. 24, 2006. All disclosure of the Taiwan application is incorporated herein by reference.

### BACKGROUND OF THE INVENTION

1. Field of the Invention

The present invention relates to a server. More particularly, the present invention relates to a web server for a monitoring system which manages cameras with a free website and a method thereof.

2. Description of Related Art

Presently, web cameras are widely applied in home security, protection, and video conference etc. However, since most monitoring systems are set up independently, a company or an individual user has to set up an entire system including cameras, data storage devices, and a host computer, such as a network video recorder (NVR), for storing and managing monitoring data captured by the cameras. To individual users and companies, setting up an entire system is too complex and expensive.

Besides, since users can only watch the monitoring images captured by the cameras through the NVR, the images cannot be watched any where at any time and cannot be shared or transmitted conveniently.

### SUMMARY OF THE INVENTION

Accordingly, the present invention is directed to a server which provides a camera management platform and a storage space through a network interface so that a user can easily set up and manage a personal low-cost monitoring system.

The present invention provides a camera management interface module. With this camera management interface module, a user can watch monitoring images in web pages and perform image edition, transmission, and management any where at any time without setting up a complex monitoring system.

The present invention provides a camera management method, wherein users manage cameras and watch monitoring images through a free website, so that a convenient monitoring system can be set up and the cost for setting up the monitoring system can be reduced.

The present invention provides a server including a camera management interface module, a network connection unit, a data processing unit, and a storage unit. The camera management interface module provides a website for a plurality of users to register and receive video/audio monitor data registered by the users and configuration data input by the users. The network connection unit is connected to a corresponding network camera according to the configuration data. The data processing unit controls the network camera according to the configuration data and obtains a video/audio monitor data corresponding to the configuration data from the network camera, and then the data processing unit stores the video/audio monitor data into the storage unit. The data processing unit establishes affiliations between the network camera and a plurality of users so that the users can browse the video/audio monitor data obtained from the network camera.

The camera management interface module further includes a device management module, an event recording module, a remote watch module, a customized configuration module. The event recording module is used for configuring the network address of the network camera. The event recording module is used for obtaining a video/audio monitor data complying with a predetermined condition from the network camera. The remote watch module is used for displaying or recording the video/audio monitor data obtained from the network camera. The customized configuration module is used for configuring an alarm notification condition and giving an alarm notification to the users when the video/audio monitor data obtained from the network camera complies with the alarm notification condition.

According to another embodiment of the present invention, the camera management interface module further includes a dynamic domain name system (DDNS) module for configuring the dynamic domain names of the users and an account management module for configuring users' accounts and passwords.

According to another embodiment of the present invention, the camera management interface module may be presented as a web page.

According to another embodiment of the present invention, the network connection unit may be connected to a network video recorder (NVR), a video server, a storage device of the network camera, an access point, etc.

According to another aspect of the present invention, a camera management method is provided. The method includes following steps. First, a website is provided for receiving a configuration data. A corresponding network camera or NVR is connected according to the configuration data. Next, the network camera is controlled according to the configuration data, and a video/audio monitor data corresponding to the configuration data is obtained from the network camera. The video/audio monitor data is then stored into a storage unit. After that, affiliations between the network camera and a plurality of users are established according to the configuration data so that the users can browse the video/audio monitor data obtained from the corresponding network camera.

According to another embodiment of the present invention, in the step of obtaining a video/audio monitor data corresponding to the configuration data, the video/audio monitor data corresponding to the configuration data is obtained from a storage device of the network camera.

According to another embodiment of the present invention, in the step of allowing the users to browse the video/audio monitor data obtained from the network camera, the video/audio monitor data obtained by the network camera during a predetermined period of time is displayed according to the configuration data.

In summary, a network interface, such as a web page or a website, is provided in the present invention for users to manage and browse monitoring images. Thus, the users can easily set up a personal monitoring system with a web server and manage or browse the monitoring images without setting up an independent NVR or a storage device. Accordingly, the present invention not only reduces the hardware cost but also improves convenience in using the monitoring system.

In order to make the aforementioned and other objects, features and advantages of the present invention comprehensible, preferred embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic block diagram of a camera management system according to an embodiment of the present invention.

FIG. 2 is a block diagram of a server according to another embodiment of the present invention.

FIG. 3 is a diagram of a camera management interface module.

FIG. 4 is a flowchart illustrating the camera management method according to another embodiment of the present invention.

### DESCRIPTION OF EMBODIMENTS

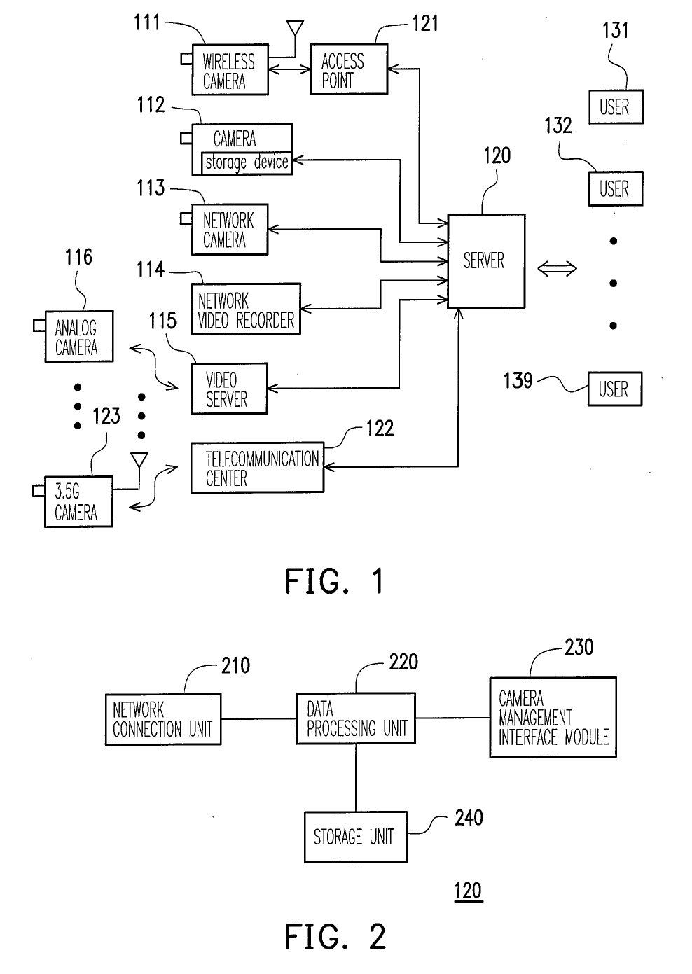

FIG. 1 is a schematic block diagram of a camera management system according to an embodiment of the present invention. Referring to FIG. 1, the server 120 provides connections and a management platform between users 131˜139 and camera devices (for example, a wireless camera 111, which may be connected through an access point 121, a camera 112 having a storage device, a network camera 113, a network video recorder (NVR) 114, or a video server 115 which may be further connected to an analog camera 116), and which is connected to a 3.5 G camera 123 in HSDPA (High Speed Downlink Packet Access, generally referred to as 3.5 G) transmission mode through a telecommunication center (for example, Chunghwa Telecom) 122.

The server 120 provides a website, with web pages thereof as a communication interface, to users 131˜139. The users 131˜139 can register video/audio monitor data and input related configuration data by using the website, wherein the configuration data includes personal account name, password, camera model, and monitor mode, or personal configurations. The server 120 connects to the corresponding camera device according to the configuration data input by a user and obtains a video/audio monitor data from the corresponding camera, so that the users 131˜139 can browse the video/audio monitor data obtained from the camera or store it into the server 120.

In other words, the users 131˜139 can control cameras and browse monitoring images through the server 120 as long as the users have installed their own cameras. Firewalls may be set up between the server 120 and the camera devices or the users for blocking off viruses or hacker' invasions. The present invention is also applicable in other conventional network server system structures, which will not be described herein. Below, those camera devices which may be connected through network will be generally referred to as network cameras, however, network cameras in the present invention are not limited to foregoing types.

FIG. 2 is a block diagram of a server according to another embodiment of the present invention. The server 120 includes a camera management interface module 230, a network connection unit 210, a data processing unit 220, and a storage unit 240. The camera management interface module 230 includes a web page for receiving the configuration data of a user. The user can configure account name, password, dynamic domain name, monitor mode (for example, pan/tilt/zoom, PZT), image display mode (for example, eMap layout, picture-on-picture), image edit, personal settings, alarm notification, and network camera model etc through options on the web page. The data processing unit 220 then connects to the network camera appointed by the user through the network connection unit 210 according to the configuration data input by the user, and obtains a video/audio monitor data required by the user from the network camera or the storage device of the network camera.

The video/audio monitor data obtained by the data processing unit 220 can be displayed instantly or stored in the storage unit 240 according to the user's configuration. The data processing unit 220 establishes an affiliation between the network camera and the user according to the configuration data input by the user, so that the user can browse the video/audio monitor data obtained from the corresponding network camera. The network connection unit 210 can be directly or indirectly connected to a network camera, a network video recorder (NVR), a video sever, a storage device of a network camera, or an access point according to the configuration data.

The camera management interface module 230 provides a web page as the communication interface between users and network cameras, and related services. The data processing unit 220 performs related calculations and configurations according to the configuration data received by the camera management interface module 230, such as the display and edit of monitoring images, network camera control, data scheduling, account management, analysis of event statistic, hard disk management etc. While in another embodiment of the present invention, the server 120 may also input configuration data related to users and network cameras through other non-network methods such as computers, input terminals of a mainframe, or direct cable connections etc.

Besides, a user may also input the configuration data through a web page so as to make the data processing unit 220 to grab a video/audio monitor data directly from the storage media of a camera device and selectively play the required monitoring images through the camera management interface module 230 in time division manner.

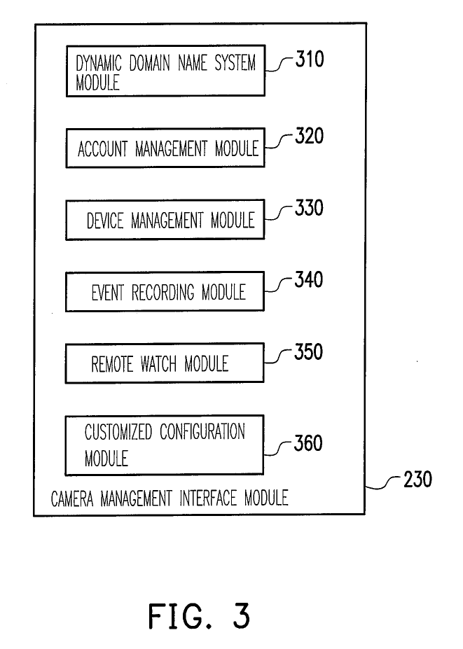

Next, the camera management interface module will be further described with reference to FIG. 3. Referring to FIG. 3, the camera management interface module 230 includes a dynamic domain name system (DDNS) module 310, an account management module 320, a device management module 330, an event recording module 340, a remote watch module 350, and a customized configuration module 360.

The DDNS module 310 is used for configuring dynamic domain names of the users so that the users can be connected to the camera management interface module 230 with floating Internet Protocol addresses. The account management module 320 provides the users with functions such as account name and password setup, account upgrade, and hard disk management etc. The device management module 330 is used for configuring network addresses of network cameras and performing functions such as “add”, “edit”, “delete”, “layout” in the configuration of the network cameras. The event recording module 340 obtains a video/audio monitor data complying with a predetermined condition from a network camera according to the condition configured by a user. The remote watch module 350 displays or records a video/audio monitor data obtained from a network camera and may also perform real-time recording. The customized configuration module 360 configures an alarm notification condition and sends an alarm to the users (for example, by e-mails, SMSs etc) when the video/audio monitor data obtained from a network camera complies with the alarm notification condition. In addition, a user may also configure a personal display panel or customizes the display settings.

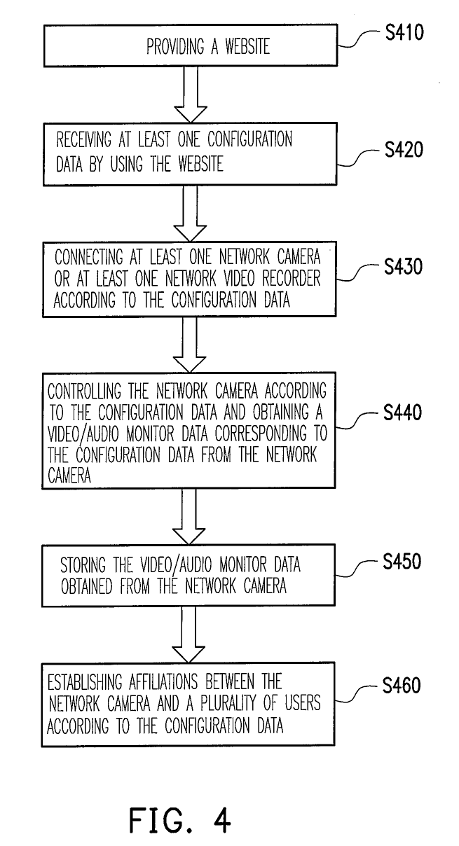

According to another aspect of the present invention, a camera management method is provided. FIG. 4 is a flowchart illustrating the camera management method according to another embodiment of the present invention. Referring to FIG. 4, first, a website is provided in step S410. At least one configuration data is then received by the website in step S420. In step S430, at least one network camera is connected according to the configuration data. Next, in step S440, the network camera is controlled and a video/audio monitor data corresponding to the configuration data is obtained from the network camera. After that, the video/audio monitor data obtained from the network camera is stored in step S450. Thereafter, in step S460, affiliations between the network camera and a plurality of users are established according to the configuration data so that the users can browse the video/audio monitor data obtained from the corresponding network camera. The remaining details of the camera management method have been described in foregoing embodiments, therefore which will not be described herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A server, comprising:
a camera management interface module, providing a website for a plurality of users to register, and receiving video/audio monitor data registered by the users and at least one configuration data input by the users;
a network connection unit, connected to at least one network camera according to the configuration data;
a data processing unit, controlling the network camera and obtaining a video/audio monitor data corresponding to the configuration data from the network camera according to the configuration data; and
a storage unit, storing the video/audio monitor data obtained from the network camera;
wherein the data processing unit establishes affiliations between the network camera and a plurality of users according to the configuration data, so as to allow the users to browse the video/audio monitor data obtained from the corresponding network camera, and the camera management interface module further comprises a device management module for configuring addresses of at least one network camera, a remote watch module for displaying or recording the video/audio monitor data obtained from the network camera according to the configuration data, an event recording module for obtaining a video/audio monitor data complying with a predetermined condition from the network camera according to the configuration data, and a customized configuration module for configuring an alarm notification condition and giving an alarm notification when the video/audio monitor data obtained from the network camera complies with the alarm notification condition.

2. The server as claimed in claim 1, wherein the camera management interface module displays the video/audio monitor data obtained from the network camera according to the configuration data.

3. The server as claimed in claim 1, wherein the camera management interface module comprises a web page.

4. The server as claimed in claim 1, wherein the camera management interface module further comprises:
a dynamic domain name system (DDNS) module, for configuring a dynamic domain name of a user; and
an account management module, for configuring an account name and a password of the user.

5. The server as claimed in claim 1, wherein the camera management interface module displays a video/audio monitor data obtained within a predetermined period of time by the network camera according to the configuration data.

6. The server as claimed in claim 1, wherein the data processing unit obtains a video/audio monitor data corresponding to the configuration data from a storage device of the network camera according to the configuration data.

7. The server as claimed in claim 1, wherein the data processing unit is further used for controlling a working track of the network camera.

8. The server as claimed in claim 1, wherein the network connection unit is connected to at least one network video decoder according to the configuration data.

9. The server as claimed in claim 1, wherein the network connection unit is connected to at least one video server according to the configuration data.

10. The server as claimed in claim 1, wherein the network connection unit is connected to at least one video server according to the configuration data, and the video server is connected to at least one analog camera.

11. The server as claimed in claim 1, wherein the network connection unit is connected to a storage device of at least one network camera according to the configuration data.

12. The server as claimed in claim 1, wherein the network connection unit is connected to at least one wireless network camera according to the configuration data.

13. A camera management interface module, comprising:
a device management module, configuring a network address of at least one network camera;
an event recording module, obtaining a video/audio monitor data complying with a predetermined condition from the network camera;
a remote watch module, displaying or recording the video/audio monitor data obtained from the network camera; and
a customized configuration module, configuring an alarm notification condition and giving an alarm notification when the video/audio monitor data obtained from the network camera complies with the alarm notification condition.

14. The camera management interface module as claimed in claim 13 further comprising:
a DDNS module, configuring a dynamic domain name of a user; and
an account management module, configuring an account name and a password of the user.

15. The camera management interface module as claimed in claim 13 comprising a web page.

16. The camera management interface module as claimed in claim 13, wherein the event recording module obtains a video/audio monitor data complying with the predetermined condition from a storage device of the network camera.

17. The camera management interface module as claimed in claim 13, wherein the remote watch module displays a video/audio monitor data obtained by the network camera during a predetermined period of time according to a configuration data.

18. A camera management method, comprising:
providing a website;
receiving at least one configuration data by using the website;
connecting at least one network camera or at least one network video recorder (NVR) to a network connection unit according to the configuration data;
controlling the network camera according to the configuration data and obtaining a video/audio monitor data corresponding to the configuration data from the network camera;
storing the video/audio monitor data obtained from the network camera; and
establishing affiliations between the network camera and a plurality of users according to the configuration data, so as to allow the users to browse the video/audio monitor data obtained from the corresponding network camera.

19. The camera management method as claimed in claim 18 further comprising obtaining a video/audio monitor data complying with a predetermined condition from the network camera;
displaying or recording the video/audio monitor data obtained from the network camera; and
configuring an alarm notification condition and giving an alarm notification when the video/audio monitor data obtained from the network camera complies with the alarm notification condition.

20. The camera management method as claimed in claim 18, wherein the step of connecting at least one network camera according to the configuration data further comprises connecting to a video server, a storage device of a network camera, or a wireless network camera.

21. The camera management method as claimed in claim 18, wherein the website comprises a web page.

22. The camera management method as claimed in claim 18, wherein the step of obtaining a video/audio monitor data corresponding to the configuration data comprises obtaining a video/audio monitor data corresponding to the configuration data from a storage device of the network camera.

23. The camera management method as claimed in claim 18, wherein the step of allowing the users to browse the video/audio monitor data obtained from the corresponding network camera comprises displaying a video/audio monitor data obtained by the network camera during a predetermined period of time according to the configuration data.

24. The camera management method as claimed in claim 18, wherein the step of establishing affiliations between the network camera and a plurality of users according to the configuration data further comprises configuring the users' account names and passwords.

25. The camera management method as claimed in claim 18, wherein the configuration data comprises dynamic domain name configuration.
